(19) United States
(12) Patent Application Publication
(10) Pub. No.: US 2022/0327976 A1
(43) Pub. Date: Oct. 13, 2022

(54) DISPLAY APPARATUS

(71) Applicant: Samsung Display Co., Ltd., Yongin-Si (KR)

(72) Inventors: KIHYUN PYUN, Gwangmyeong-si (KR); WONJIN SEO, Seoul (KR)

(21) Appl. No.: 17/539,650

(22) Filed: Dec. 1, 2021

(30) Foreign Application Priority Data
Apr. 7, 2021 (KR) 10-2021-0045364

(51) Int. Cl. G09G 3/20

(52) U.S. Cl. CPC G09G 3/20; G09G 2310/08; G09G 2320/0257; G09G 2320/103

(57) ABSTRACT

A display apparatus may count a number of frames and adjust a cycle of clock training operations depending on a frame count number in a data-sensing driver to prevent or reduce unnecessary clock training operations. The data-sensing driver may perform more sensing operations by increasing the number of sensing operations and reducing the number of clock training operations. As a result, the data-sensing driver can quickly sense deterioration of a display panel of the display apparatus, and prevent or reduce a momentary afterimage, thereby improving a display quality.

### PRIORITY STATEMENT

This application claims priority under 35 U.S.C. § 119 to Korean Patent Application No. 10-2021-0045364, filed on Apr. 7, 2021, in the Korean Intellectual Property Office (KIPO), the disclosure of which is herein incorporated by reference in its entirety.

### BACKGROUND

### 1. Field

The present inventive concept relates to a display apparatus. More particularly, the present inventive concept relates to a display apparatus capable of efficiently performing sensing operations and clock training operations.

### 2. Description of the Related Art

Generally, a display apparatus includes a display panel and a display panel driver. The display panel includes a plurality of gate lines, a plurality of data lines, and a plurality of pixels. The display panel driver includes a gate driver providing gate signals to the gate lines, a data driver providing data voltages to the data lines, and a driving controller controlling the gate driver and the data driver.

Recently, a display apparatus including a data-sensing driver has been developed. The data-sensing driver provides data voltages to the data lines and receives sensing signals from the display panel via a plurality of sensing lines.

The data driver (or the data-sensing driver) may read a logic level of a data signal received from the driving controller using a clock signal. The driving controller may provide the clock signal to the data driver (or the data-sensing driver) via a separate clock signal channel. Recently, an interface has been developed between the driving controller and the data driver (or the data-sensing driver) for the driving controller to transmit a clock-embedded data signal (or clock-embedded differential signal) to the data driver (or the data-sensing driver), and the data driver (or the data-sensing driver) recovers a data signal and a clock signal from the clock-embedded data signal that is received from the driving controller. In such an interface, the driving controller may transmit a training pattern in the clock-embedded data signal, and the data driver (or the data-sensing driver) may perform a clock training operation to recover the clock signal based on the training pattern. A conventional display apparatus may perform the clock training operation in every frame even when the clock training operation may be unnecessary.

### SUMMARY

According to an embodiment of the present inventive concept, a display apparatus is capable of adjusting a cycle of a clock training operation depending on a frame count number, and reducing or preventing unnecessary clock training operations. The display apparatus can quickly sense deterioration of a display panel by increasing a number of sensing operations and reducing a number of the clock training operations, thereby reducing or preventing a momentary afterimage.

According to an embodiment of the present inventive concept, a display apparatus is capable of adjusting a cycle of a clock training operation depending on a time count number, and reducing or preventing unnecessary clock training operations. The display apparatus can quickly sense deterioration of a display panel by increasing a number of sensing operations and reducing a number of the clock training operations, thereby reducing or preventing a momentary afterimage.

In an embodiment of the present inventive concept, the display apparatus includes a display panel that includes a plurality of pixels, a gate driver configured to provide gate signals to the plurality of pixel, a driving controller configured to provide a clock-embedded data signal that includes image data and a training pattern, and a data-sensing driver configured to receive the clock-embedded data signal from the driving controller, and provide data voltages corresponding to the image data to the plurality of pixels in an active period. The data-sensing driver determines a set frame number depending on a frame count number, and performs a clock training operation based on the training pattern in a blank period of one frame of one or more frames that are set by the set frame number.

In an embodiment, the data-sensing driver may perform a sensing operation in the blank period while the clock training operation is not performed.

In an embodiment, the data-sensing driver may generate the frame count number by counting the number of frames. In a case in which a clock recovery operation is abnormally performed, the data-sensing driver may initialize the frame count number and perform the clock training operation in a subsequent frame.

In an embodiment, the driving controller may provide set information about a plurality of set frame numbers corresponding to a plurality of frame count numbers to the data-sensing driver.

In an embodiment, the data-sensing driver may inform the driving controller whether the clock recovery operation is normal or abnormal through a shared back channel.

In an embodiment, the driving controller may inform the data-sensing driver that the training pattern is transmitted in the clock-embedded data through shared forward channel.

In an embodiment, the set frame number may be changed as the frame count number is increased by a reference frame number.

In an embodiment, the set frame number may be increased by one as the frame count number is increased by the reference frame number.

In an embodiment, the set frame number may be doubled as the frame count number is increased by the reference frame number.

In an embodiment, the reference frame number may be increased when the clock recovery operation is abnormally performed.

In an embodiment of the present inventive concept, the display apparatus includes a display panel including a plurality of pixels, a gate driver configured to provide gate signals to the plurality of pixels, a data-sensing driver, and a driving controller configured to provide a clock-embedded data signal that includes image data, a training pattern, and set information. The data-sensing driver includes a clock trainer configured to receive the clock-embedded data signal from the data controller and output the image data in an active period, perform a clock training operation based on the training pattern in a blank period, and output a first lock fail signal in response to an abnormal clock recovery operation, a frame counter configured to generate a frame count number by counting the number of frames, and a clock training controller configured to receive the frame count number and the set information about a plurality of set frame numbers corresponding to a plurality of frame count numbers, and determine a set frame number among the plurality of set frame numbers depending on the frame count number. The driving controller includes a shared forward channel transmitter configured to provide a shared forward channel signal that informs the clock trainer that the training pattern is transmitted and a clock-embedded data transmitter configured to transmit the clock-embedded data signal to the data-sensing driver.

In an embodiment, the data-sensing driver further may include a decoder configured to receive the clock-embedded data signal and decode the set information, and a shared back channel transmitter configured to generate a shared back channel signal based on the first lock fail signal, and transmit information about the set frame number and the shared back channel signal to a shared back channel receiver. The driving controller may further include the shared back channel receiver that is configured to generate a second lock fail signal based on the shared back channel signal, and provide the information about the set frame number and the second lock fail signal to the shared forward channel transmitter and the clock-embedded data transmitter.

In an embodiment of the present inventive concept, the display apparatus includes a display panel including a plurality of pixels, a gate driver configured to provide gate signals to the plurality of pixels, a driving controller configured to provide a clock-embedded data signal that includes image data and a training pattern, and a data-sensing driver configured to receive the clock-embedded data signal from the driving controller, and provide data voltages corresponding to the image data to the plurality of pixels in an active period. The data-sensing driving determines a set frame number depending on a time count number, and performs a clock training operation based on the training pattern in a blank period of one frame of one or more frames that are set by the set frame number.

In an embodiment, the data-sensing driver may perform a sensing operation in the blank period while the clock training operation is not performed.

In an embodiment, the data-sensing driver may generate the time count number by counting time. In a case in which a clock recovery operation is abnormally performed, the data-sensing driver may initialize the time count number and perform the clock training operation in a subsequent frame.

In an embodiment, the driving controller may provide set information about a plurality of set frame numbers corresponding to a plurality of time count numbers to the data-sensing driver.

In an embodiment, the data-sensing driver may inform the driving controller whether the clock recovery operation is normal or abnormal through a shared back channel. The driving controller may inform the data-sensing driver that the training pattern is transmitted in the clock-embedded data through shared forward channel.

In an embodiment, the set frame number may be changed as the time count number is increased by a reference time.

In an embodiment, the set frame number may be increased by one as the time count number is increased by the reference time.

In an embodiment, the reference time may be increased when the clock recovery operation is abnormally performed.

According to the present inventive concept, the data-sensing driver may count a number of frames and adjust a cycle of the clock training operation depending on the frame count number to prevent or reduce unnecessary clock training operations. The data-sensing driver may perform sensing operations more frequently by increasing the number of sensing operations and reducing the number of clock training operations. As a result, deterioration of the display panel may be quickly sensed, and a momentary afterimage may be prevented or reduced.

However, the effects of the present disclosure are not limited to the above-described effects, and may be variously expanded, modified, and/or deviated without departing from the spirit and scope of the present disclosure.

### BRIEF DESCRIPTION OF THE DRAWINGS

The above and other features and advantages of the present inventive concept will become more apparent by describing detailed embodiments thereof with reference to the accompanying drawings, in which:

FIG. 1 is a block diagram illustrating a display apparatus according to an embodiment of the present inventive concept;

FIG. 2 is a diagram illustrating a configuration of a clock-embedded data signal for one frame according to an embodiment of the present inventive concept;

FIG. 3 is a diagram illustrating an operation of the data-sensing driver;

FIG. 4 is a plan diagram illustrating the display apparatus of FIG. 1 according to an embodiment of the present inventive concept;

FIG. 5 is a plan diagram illustrating a signal path through which a shared back channel signal is transmitted from data driving chips to a driving controller;

FIG. 6 is a plan diagram illustrating a signal path through which a shared forward channel signal is transmitted from a driving controller to data driving chips;

FIG. 7 is a graph illustrating a relationship between a frame count number and a set frame number in a normal clock recovery operation according to an embodiment of the present inventive concept;

FIG. 8A is a diagram illustrating an operation of a data-sensing driver in a blank period in a case where a set frame number is 1;

FIG. 8B is a diagram illustrating an operation of a data-sensing driver in a blank period in a case where a set frame number is 2;

FIG. 8C is a diagram illustrating an operation of a data-sensing driver in a blank period in a case where a set number of frames is 4;

FIG. 9 is a graph illustrating a relationship between a frame count number and a set frame number in an event of a lock fail according to an embodiment of the present inventive concept;

FIG. 10 is a graph illustrating a relationship between a frame count number and a set frame number in a normal clock recovery operation according to an embodiment of the present inventive concept;

FIG. 11 is a graph illustrating a relationship between a frame count number and a set frame number in an event of a lock fail according to an embodiment of the present inventive concept;

FIG. 12 is a block diagram illustrating a driving controller and a data-sensing driver according to an embodiment of the present inventive concept;

FIG. 13 is a graph illustrating a relationship between a time count number and a set frame number in a normal clock recovery operation according to an embodiment of the present inventive concept;

FIG. 14 is a graph illustrating a relationship between a time count number and a set frame number in an event of a lock fail according to an embodiment of the present inventive concept;

FIG. 15 is a graph illustrating a relationship between a time count number and a set frame number in a normal clock recovery operation according to an embodiment of the present disclosure; and

FIG. 16 is a graph illustrating a relationship between a time count number and a set frame number in an event of a lock fail according to an embodiment of the present inventive concept.

### DETAILED DESCRIPTION OF THE INVENTIVE CONCEPT

Hereinafter, the present inventive concept will be explained in detail with reference to the accompanying drawings.

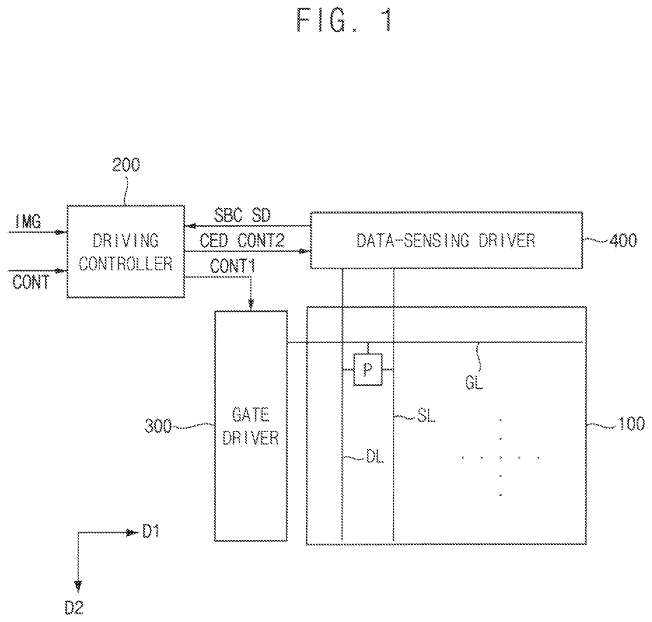

FIG. 1 is a block diagram illustrating a display apparatus according to an embodiment of the present inventive concept.

Referring to FIG. 1, the display apparatus includes a display panel 100 and a display panel driver. The display panel driver includes a driving controller 200, a gate driver 300, and a data-sensing driver 400.

In an embodiment, the driving controller 200 and the data-sensing driver 400 may be integrally formed. In another embodiment, the driving controller 200 and the data-sensing driver 400 may be implemented with a single integrated circuit. The single integrated circuit including the driving controller 200 and the data-sensing driver 400 may be referred to as a timing controller embedded data driver (TED).

The display panel 100 may include a plurality of pixels P. In an embodiment, the display panel 100 may be an organic light emitting diode display panel that includes an organic light emitting diode.

The display panel 100 includes a plurality of gate lines GL, a plurality of data lines DL, and the plurality of pixels P coupled to the gate lines GL and the data lines DL. The gate lines GL may extend in a first direction D1, and the data lines DL may extend in a second direction D2 that crosses the first direction D1.

In an embodiment, the display panel 100 may further include a plurality of sensing lines SL coupled to the pixels P, and the display panel driver may further include a sensing circuit that receives sensing signals through the sensing lines SL from the pixels P. The sensing circuit may be implemented in the data-sensing driver 400. Alternatively, the sensing circuit may be implemented independently of the data-sensing driver 400. It is noted that the sensing circuit of the present inventive concept is not limited to a specific implementation.

In the present embodiment, the driving controller 200 receives input image data IMG and an input control signal CONT from an external apparatus (not shown). In an embodiment, the input image data IMG may include red image data, green image data and blue image data. The input image data IMG may further include white image data. In another embodiment, the input image data IMG may include magenta image data, yellow image data, and cyan image data. The input control signal CONT may include a master clock signal and a data enable signal. The input control signal CONT may further include a vertical synchronizing signal and a horizontal synchronizing signal.

The driving controller 200 generates a first control signal CONT1, a second control signal CONT2, and a clock-embedded data signal CED based on the input image data IMG and the input control signal CONT. The clock-embedded data signal CED may include clock information.

The driving controller 200 generates the first control signal CONT1 for controlling an operation of the gate driver 300 based on the input control signal CONT, and outputs the first control signal CONT1 to the gate driver 300. The first control signal CONT1 may include a vertical start signal and a gate clock signal.

In addition, the driving controller 200 generates the second control signal CONT2 for controlling an operation of the data-sensing driver 400 based on the input control signal CONT, and outputs the second control signal CONT2 to the data-sensing driver 400. The second control signal CONT2 may include a horizontal start signal and a load signal.

In an embodiment, the second control signal CONT2 may include a shared forward channel signal SFC that indicates a clock training period. In an embodiment, the driving controller 200 may receive from the data-sensing driver 400 sensing data SD that include information about a threshold voltage and/or mobility of the pixels P and a shared back channel signal SBC that indicates whether a clock recovery operation is normal or abnormal. In an embodiment, the driving controller may receive information about a set frame number. A description of the information about a set frame number will be given later. In the present embodiment, the clock recovery operation may refer to an operation in which the data-sensing driver 400 generates a clock signal.

The driving controller 200 further generates the clock-embedded data signal CED based on the input image data IMG. The driving controller 200 outputs the clock-embedded data signal CED to the data-sensing driver 400.

The gate driver 300 may provide gate signals to the plurality of pixels P. The gate driver 300 generates the gate signals for driving the gate lines GL in response to the first control signal CONT1 that is received from the driving controller 200, and outputs the gate signals to the gate lines GL. The gate driver 300 may sequentially output the gate signals to the gate lines GL.

The data-sensing driver 400 receives the second control signal CONT2 and the clock-embedded data signal CED from the driving controller 200. The data-sensing driver 400 recovers or restores image data from the clock-embedded data signal CED. The data-sensing driver 400 converts the image data into data voltages of an analog type, and outputs the data voltages to the data lines DL.

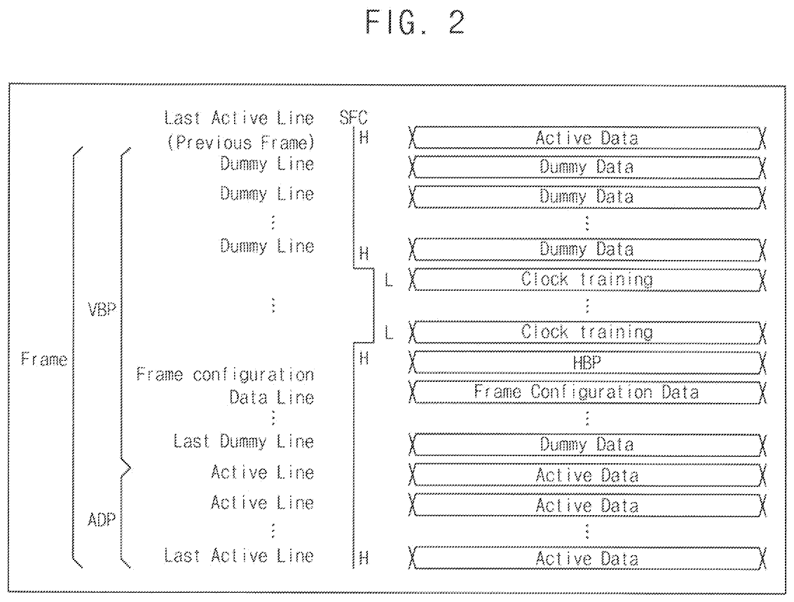

FIG. 2 is a diagram illustrating a configuration of a clock-embedded data signal CED for one frame according to an embodiment of the present inventive concept.

Referring to FIG. 2, each frame may include an active period ADP and a blank period VBP. The clock-embedded data signal CED may include a plurality of active line data (also referred to as Active Data) in the active period ADP. Each active line data may include image data. The clock embedded data signal CED may further include a plurality of dummy line data (also referred to as Dummy Data) and a frame configuration data (also referred to as Frame Configuration Data) in the blank period VBP. In an embodiment, the frame configuration data may include set information about a plurality of set frame numbers corresponding to a plurality of frame count numbers. The clock embedded data signal CED may further include a plurality of clock training line data (also referred to as Clock training) in the blank period VBP. Each clock training line data may include a training pattern. In an embodiment, the clock-embedded data signal CED may further include blank data HBP in the blank period VBP. While the clock training line data or the training pattern is transmitted, the shared forward channel signal SFC may have a low level. Details of a frame count number and the set information will be described below.

The data-sensing driver 400 may perform a sensing operation in the blank period VBP based on the clock-embedded data signal CED. The clock-embedded data signal CED may include data related to the sensing operation. The clock-embedded data signal CED may not include the clock training line data in a case where a clock training operation is not performed.

The data-sensing driver 400 may perform the clock training operation using the training pattern in the blank period VBP. The clock training operation may include the clock recovery operation and an additional operation that adjusts a frequency and/or a phase of the clock signal so that the clock signal has a frequency and/or a phase corresponding to the training pattern.

The data-sensing driver 400 may provide data voltages corresponding to the image data based on the clock-embedded data signal CED to the plurality of pixels P in an active period ADP.

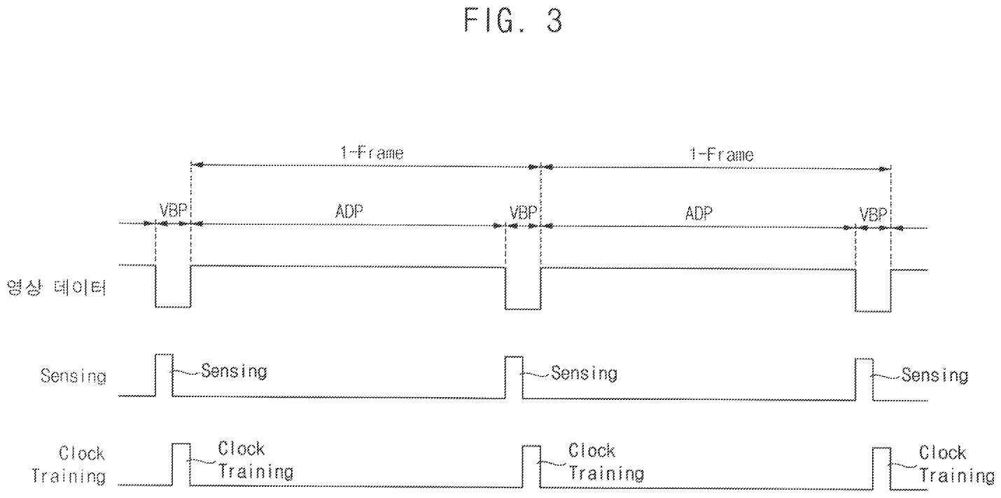

FIG. 3 is a diagram illustrating an operation of the data-sensing driver 400. When the image data is high value, the clock embedded data signal CED may include the image data. When the image data is low value, the clock embedded data signal CED may not include the image data. When the sensing operation (also referred to as Sensing) is high value, the sensing operation may be performed. When the sensing operation is low value, the sensing operation may not be performed. When the clock training operation (also referred to as Clock Training) is high value, the clock training operation may be performed. When the clock training operation is low value, the clock training operation may not be performed.

Referring to FIG. 3, the image data may be included in the clock-embedded data signal CED in the active period ADP. The image data may not be included in the clock-embedded data signal CED in the blank period VBP. The data-sensing driver 400 may perform the clock training operation using the training pattern included in the clock-embedded data signal CED in the blank period VBP. The data-sensing driver 400 may perform a sensing operation while the clock training operation is not performed in the blank period VBP. In an embodiment, the data-sensing driver 400 may perform the sensing operation first in a case where both the clock training operation and the sensing operation are performed in the blank period VBP. For example, the data-sensing driver 400 may perform the sensing operation in the first half of the blank period VBP, and perform the clock training operation in the second half of the blank period VBP.

The data-sensing driver 400 may perform the sensing operation while the clock training operation is not performed in the blank period VBP. Details of this will be described below.

The sensing operation may include receiving a sensing signal from pixels P of the display panel 100 via the sensing lines SL and generating the sensing data SD based on the sensing signal. The sensing signal may be a current signal.

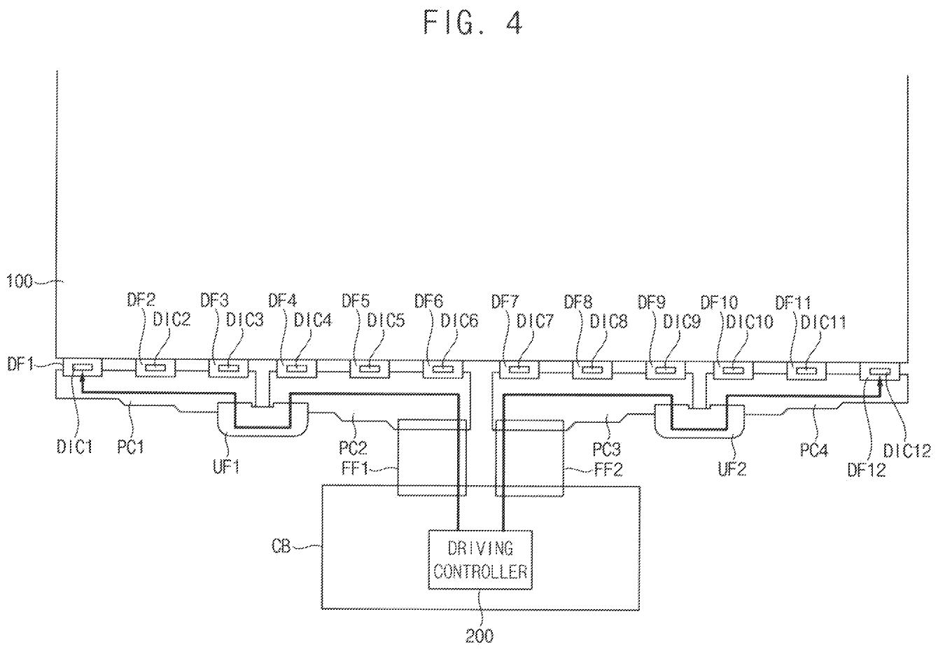

FIG. 4 is a plan diagram illustrating the display apparatus of FIG. 1 according to an embodiment of the present inventive concept.

Referring to FIG. 1 and FIG. 4, the display apparatus may include a control board CB, a first printed circuit board PC1, a second printed circuit board PC2, a first flexible film FF1 that is connected to the second printed circuit board PC2 and the control board CB, and a first U-film UF1 that is connected to the first printed circuit board PC1 and the second printed circuit board PC2.

The display apparatus may further include a third printed circuit board PC3, a fourth printed circuit board PC4, a second flexible film FF2 that is connected to the third printed circuit board PC3 and the control board CB, a second U-film UF2 that is connected to the third printed circuit board PC3 and the fourth printed circuit board PC4.

The display apparatus may further include data films DF1, DF2, and DF3 that are connected between the first printed circuit board PC1 and the display panel 100, data driving chips DIC1, DIC2, and DIC3 that are placed on the data films DF1, DF2, and DF3, data films DF4, DF5, and DF6 that are connected between the second printed circuit board PC2 and the display panel 100, and data driving chips DIC4, DIC5, and DIC6 that are placed on the data films DF4, DF5, and DF6.

The display apparatus may further include data films DF7, DF8, and DF9 that are connected between the third printed circuit board PC3 and the display panel 100, data driving chips DIC7, DIC8, and DIC9 that are placed on the data films DF7, DF8, and DF9, data films DF10, DF11, and DF12 that are connected between the forth printed circuit board PC4 and the display panel 100, and data driving chips DIC10, DIC11, and DIC12 that are placed on the data films DF10, DF11, and DF12.

The present embodiment illustrates that the display apparatus includes 12 data driving chips DIC1 to DIC12, but the present inventive concept is not limited to any particular number of data driving chips.

The driving controller 200 may transmit the second control signal CONT2 and the clock-embedded data signal CED to the data-sensing driver 400 through an input/output interface. For example, the driving controller 200 may transmit the second control signal CONT2 and the clock-embedded data signal CED to the data-sensing driver 400 through a Unified Standard Interface for TV (USI-T).

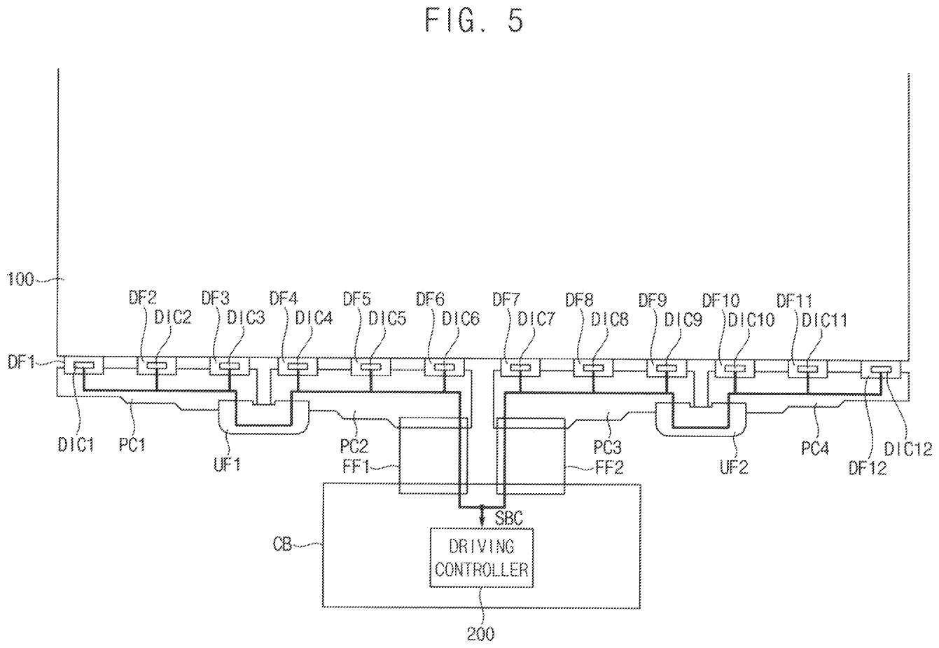

FIG. 5 is a plan diagram illustrating a signal path through which the shared back channel signal SBC is transmitted from the data driving chips DIC1 to DIC12 to the driving controller 200.

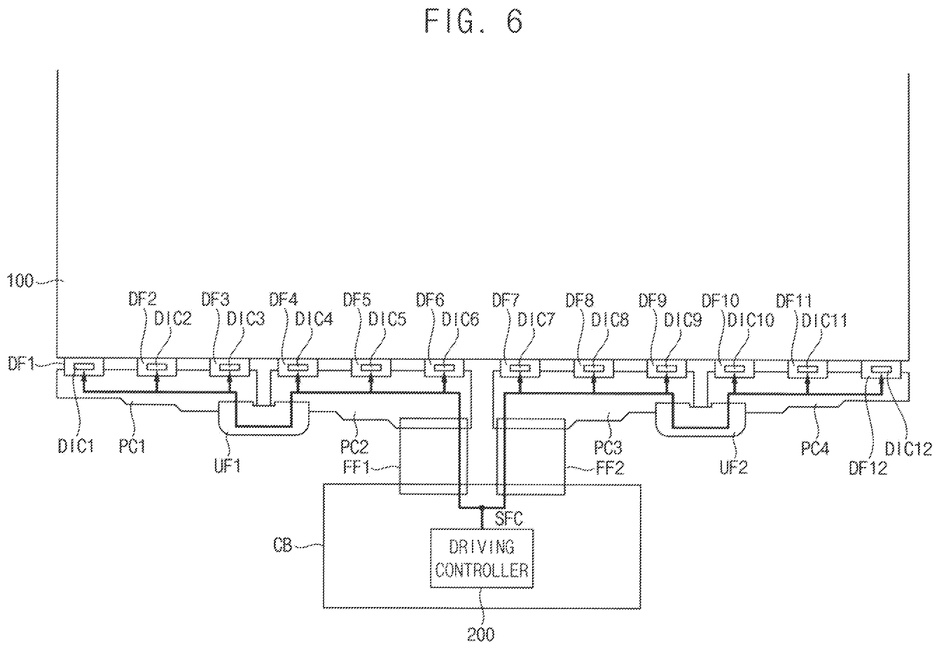

FIG. 6 is a plan diagram illustrating a signal path through which the shared forward channel signal SFC is transmitted from the driving controller 200 to the data driving chips DIC1 to DIC12.

Referring to FIGS. 1, 4, 5 and 6, the driving controller 200 may inform the data-sensing driver 400 that the training pattern is transmitted in the clock-embedded data signal CED through a shared forward channel. The second control signal CONT2 may include the shared forward channel signal SFC. The shared forward channel signal SFC may be a low value while the training pattern is transmitted in the clock-embedded data signal CED to the data-sensing driver 400. The data-sensing driver 400 may inform the driving controller 200 whether the clock recovery operation is normal or not through a shared back channel. The shared back channel may transmit the shared back channel signal SBC from the data-sensing driver 400 to the driving controller 200. The shared back channel signal SBC may change from a high value to a low value to indicate that the clock recovery operation abnormally operates.

Referring to FIG. 5, the shared back channel signal SBC that is outputted from the first data driving chip DIC1 may transmit to the driving controller 200 through the first data film DF1, the first printed circuit board PC1, the first U-film UF1, the second printed circuit board PC2, the first flexible film FF1, and the control board CB.

Referring to FIG. 6, the shared forward channel signal SFC from the driving controller 200 may be transmitted to the first data driving chip DIC1 in an opposite direction of the transmission path of the shared back channel signal SBC that is transmitted from the first data driving chip DIC1 to the driving controller 200.

For example, the shared back channel signal SBC that is outputted from the fourth data driving chip DIC4 may be transmitted to the driving controller 200 through the fourth data film DF4, the second printed circuit board PC2, the first flexible film FF1, and the control board CB.

The shared forward channel signal SFC from the driving controller 200 may be transmitted to the fourth data driving chip DIC4 in an opposite direction of the transmission path of the shared back channel signal SBC that is transmitted from the forth data driving chip DIC4 to the driving controller 200.

In another example, the shared back channel signal SBC that is outputted from the seventh data driving chip DIC7 may be transmitted to the driving controller 200 through the seventh data film DF7, the third printed circuit board PC3, the second flexible film FF2, and the control board CB.

The shared forward channel signal SFC from the driving controller 200 may be transmitted to the seventh data driving chip DIC7 in an opposite direction of the transmission path of the shared back channel signal SBC that is outputted from the seventh data driving chip DIC7 to the driving controller 200.

In another example, the shared back channel signal SBC that is outputted from the tenth data driving chip DIC10 may be transmitted to the driving controller 200 through the tenth data film DF10, the fourth printed circuit board PC4, the second U-film UF2, the third printed circuit board PC3, the second flexible film FF2, and the control board CB.

The shared forward channel signal SFC from the driving controller 200 may be transmitted to the tenth data driving chip DIC10 in an opposite direction of the transmission path of the shared back channel signal SBC that is outputted from the tenth data driving chip DIC10. The data-sensing driver 400 may provide the set information through the shared back channel that transmits the shared back channel signal SBC.

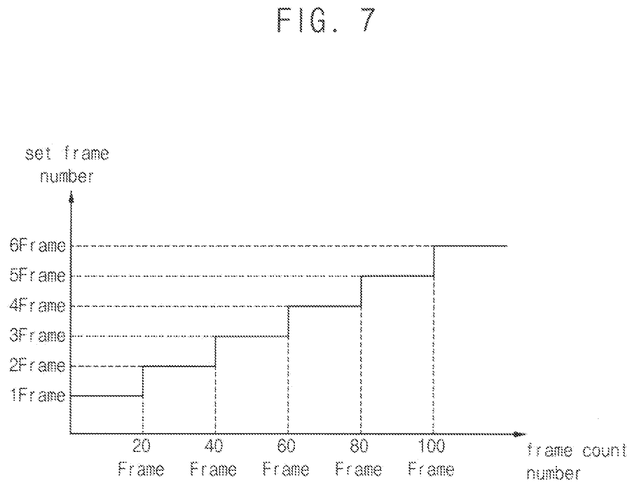

FIG. 7 is a graph illustrating a relationship between a frame count number and a set frame number in a normal clock recovery operation according to an embodiment of the present inventive concept. A case in which the clock recovery operation is abnormally performed is also referred to as a lock fail. In other words, the relationship between the frame count number and the set frame number illustrated in FIG. 7 refers to a case in which a lock fail does not occur.

The data-sensing driver 400 may generate the frame count number by counting the number of frames. The data-sensing driver 400 may count the number of frames after the display apparatus is powered on.

The data-sensing driver 400 may adjust a cycle of the clock training operation depending on the set frame number. For example, in a case where the set frame number is four, the data-sensing driver 400 may perform the clock training operation in the blank period VBP of one frame of four frames that are set by the set frame number.

The set information may include information about a plurality of set frame numbers, which may be preset. The driving controller 200 may provide the set information about the plurality of the set frame number corresponding to a plurality of frame count numbers to the data-sensing driver 400.

Referring to FIG. 7, the data-sensing driver 400 may determine a set frame number depending on a frame count number, and perform the clock training operation using the training pattern in the blank period VBP of one frame of one or more frames that are set by the set frame number. The data-sensing driver 400 may count the number of frames and generate the frame count number. The set frame number may be changed as the frame count number is increased by a reference frame number. The set frame number may be increased by one as the frame count number is increased by the reference frame number.

In the present example in which the reference frame number is 20, the set frame number may increase by one as the frame count number is increased by 20. As a result, the data-sensing driver 400 may perform the clock training operation per one frame while the frame count number is between 0 and 20 frames. The data-sensing driver 400 may perform the clock training operation per two frames while the frame count number is between 20 and 40 frames.

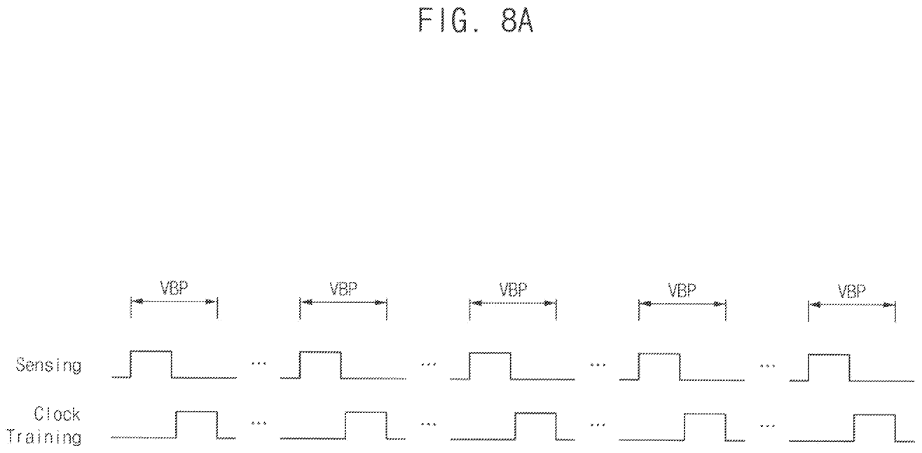

FIG. 8A is a diagram illustrating an operation of the data-sensing driver 400 in a blank period VBP in a case where the set frame number is 1. A period that is indicated by three dots represents the active period ADP.

Referring to FIG. 8A, the data-sensing driver 400 may first perform the sensing operation and then perform the clock training operation in the blank period VBP of the first frame. Because the set frame number is 1, the data-sensing driver 400 may perform the sensing operation and the clock training operation in a blank period VBP of each frame.

FIG. 8B is a diagram illustrating an operation of the data-sensing driver 400 in a blank period VBP in a case where the set frame number is 2. A period that is indicated by three dots represents the active period ADP.

Referring to FIG. 8B, the data-sensing driver 400 may perform the sensing operation while the clock training operation is not performed in the blank period VBP. For example, the data-sensing driver 400 may not perform the clock training operation during the blank period VBP of a first frame. In this case, the data-sensing driver 400 may perform only the sensing operation in the blank period VBP of the first frame. The data-sensing driver 400 may perform the clock training operation in the blank period VBP of a second frame. In this case, the data-sensing driver 400 may perform the sensing operation in the blank period VBP of the second frame in a relatively shorter time than that of the first frame. The data-sensing driver 400 may perform the clock training operation in a remaining period of the blank period VBP of the second frame. The embodiment of FIG. 8B may perform more sensing operations than the embodiment of FIG. 8A. As a result, deterioration of the display panel 100 may be quickly sensed, and a momentary afterimage may be prevented or reduced.

FIG. 8C is a diagram illustrating an operation of the data-sensing driver 400 in a blank period VBP in a case where a set number of frames is 4. A period that is indicated by three dots represents the active period ADP.

Referring to FIG. 8C, the data-sensing driver 400 may perform the sensing operation while the clock training operation is not performed in the blank period VBP. For example, the data-sensing driver 400 may not perform the clock training operation during the blank period VBP of a first frame, a second frame, or a third frame. In this case, the data-sensing driver 400 may perform only the sensing operation in the blank period VBP of the first frame, the second frame, or the third frame. The data-sensing driver 400 may perform the clock training operation in the blank period VBP of a fourth frame. In this case, the data-sensing driver 400 may perform the sensing operation in the blank period VBP of the fourth frame in a relatively shorter time than that of the first frame, the second frame, or the third frame. The data-sensing driver 400 may perform the clock training operation in a remaining period of the blank period VBP of the fourth frame. The embodiment of FIG. 8C may perform more sensing operations than the embodiments of FIGS. 8A and 8B. As a result, deterioration of the display panel 100 may be quickly sensed, and a momentary afterimage may be prevented or reduced.

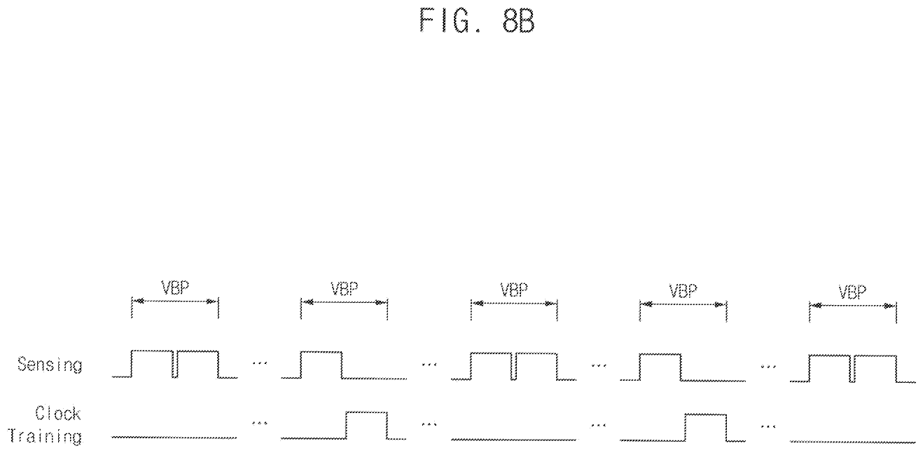

FIG. 9 is a graph illustrating a relationship between a frame count number and a set frame number in an event of a lock fail according to an embodiment of the present inventive concept.

Referring to the FIG. 9, when a lock fail occurs, or a clock recovery operation is abnormally performed, the data-sensing driver 400 may initialize or reset the frame count number and perform the clock training operation in a next frame.

For example, when the lock fail occurs, the data-sensing driver 400 may initialize or reset the frame count number, and repeat the clock recovery operation. As a result, the set frame number may be determined depending on the frame count number initialized.

In the present example in which the reference frame number is 20, the set frame number may be increased by one as the frame count number is increased by 20. As a result, the data-sensing driver 400 may perform the clock training operation per one frame while the frame count number is between 0 and 20 frames. The data-sensing driver 400 may perform the clock training operation per two frames while the frame count number is between 20 and 40 frames. Upon detecting the lock fail, the data-sensing driver 400 may reset the set frame number and perform the clock training operation in the next 20 frames and repeat the clock training operation by increasing the set frame number every 20 frames.

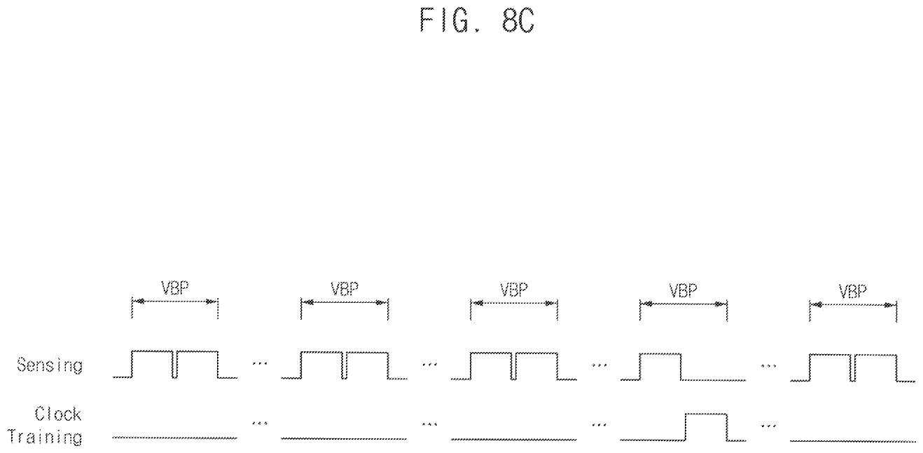

FIG. 10 is a graph illustrating a relationship between the frame count number and the set frame number in a normal clock recovery operation according to an embodiment of the present inventive concept.

Referring to FIG. 10, the set frame number is doubled as the frame count number is increased by the reference frame number.

In the present example in which the reference frame number is 20, the set frame number may be initially increased by one as the frame count number reaches 20. The set frame number may be increased to two that is a double of the initial set frame number as the frame count number reaches 40. Next, the set frame number may be increased to four that is a double of the previous set frame number as the frame count number reaches 60 frames. Accordingly, the data-sensing driver 400 may initially perform the clock training operation per one frame while the frame count number is 1 to 20 frames. Subsequently, the data-sensing driver 400 may perform the clock training operation per two frames while the frame count number is between 20 and 40 frames, may perform the clock training operation per four frames while the frame count number is between 40 and 60 frames, and may repeat the clock training operation.

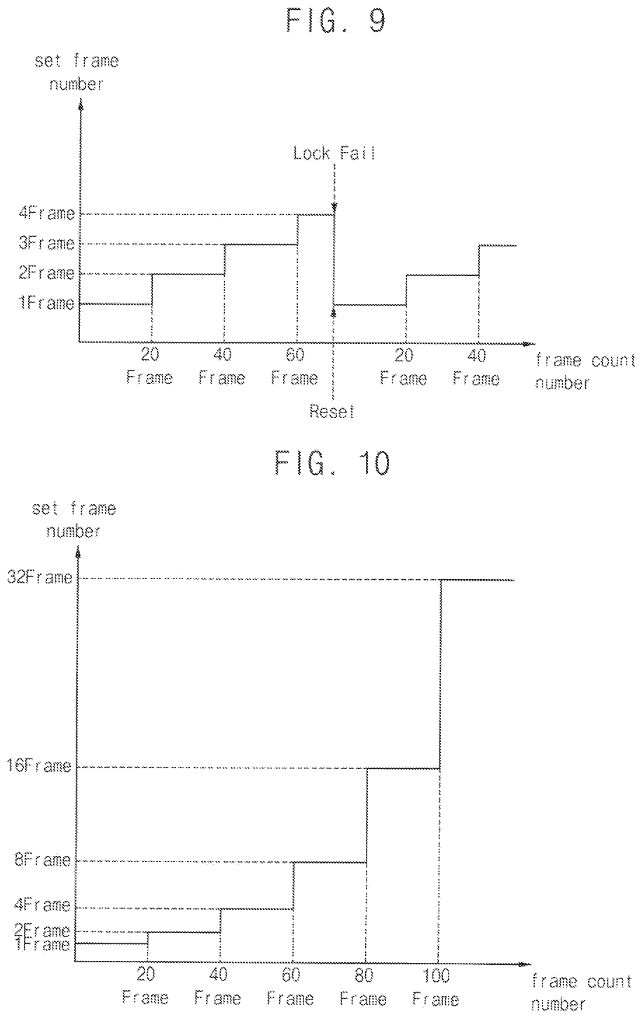

FIG. 11 is a graph illustrating a relationship between a frame count number and a set frame number in an event of a lock fail according to an embodiment of the present inventive concept.

Referring to FIG. 11, when a lock fail occurs or a clock recovery operation is abnormally performed, the data-sensing driver 400 may initialize the frame count number and perform the clock training operation in a next frame. After the set frame number is initialized or reset, the reference frame number may be increased when the clock recovery operation is abnormally performed, in the present example, from 20 frames to 30 frames.

In the present example in which the first reference frame number is 20, the set frame number may be doubled as the frame count number is increased by 20. As a result, the data-sensing driver 400 may perform the clock training operation per one frame while the frame count number is between 0 and 20 frames. The data-sensing driver 400 may perform the clock training operation per two frames while the frame count number is between 20 and 40 frames. Upon detecting the lock fail, the data-sensing driver 400 may initialize the frame count number and perform the clock training operation per one frame again. After the lock fail, the reference frame number may be increased, for example, from 20 to 30. As a result, the data-sensing driver 400 may perform the clock training operation per one frame while the frame count number is between the next 0 and 30 frames. The data-sensing driver 400 may perform the clock training operation per two frames while the frame count number is between the next 30 and 60 frames.

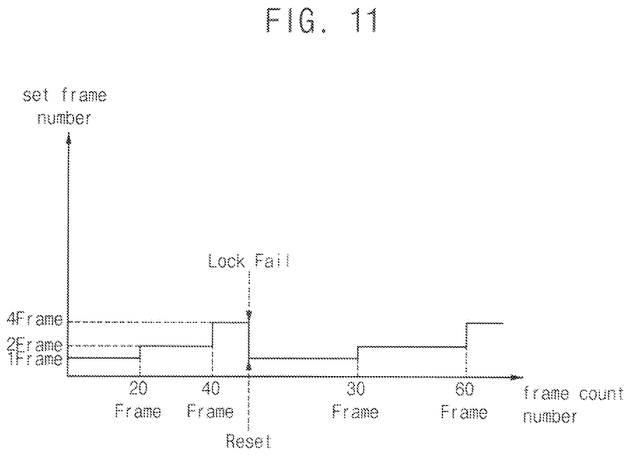

FIG. 12 is a block diagram illustrating the driving controller 200 and the data-sensing driver 400 according to an embodiment of the present inventive concept.

Referring to FIG. 12, the data-sensing driver 400 may include a clock trainer 410, a frame counter 420, a clock training controller 430, a decoder 440, and a shared back channel transmitter 450. The driving controller 200 may include a shared forward channel transmitter 210, a clock-embedded data transmitter 220, and a shared back channel receiver 230.

The clock trainer 410 may receive the clock-embedded data signal CED in the active period ADP and output image data recovered from the clock-embedded data signal CED in the active period ADP. The clock trainer 410 may perform the clock training operation using the training pattern included in the clock-embedded data signal CED in the blank period VBP. For example, the clock trainer 410 may output a first lock fail signal LF1 when the clock recovery operation is abnormally performed. The frame counter 420 may generate a frame count number CF by counting the number of frames. The clock training controller 430 may receive the frame count number CF and a set information CI about a plurality of set frame numbers corresponding to a plurality of frame count numbers. The clock training controller 430 may determine the set frame number depending to the frame count number CF.

The decoder 440 may receive the clock-embedded data signal CED, decode the set information included in the clock-embedded data signal CED, and output the set information CI to the clock training controller 430. The clock training controller 430 may determine the set frame number based on the frame count number CF and the set information CI, and may output information TT about the set frame number to the shared back channel transmitter 450. The shared back channel transmitter 450 may transmit the information TT about the set frame number and the shared back channel signal SBC to the shared back channel receiver 230 of the driving controller 200. The shared back channel transmitter 450 may change the shared back channel signal SBC from a high value to a low value based on the first lock fail signal LF1 received from the clock trainer 410.

The shared forward channel transmitter 210 of the driving controller 200 may provide the shared forward channel signal SFC to the clock trainer 410 of the data-sensing driver 400 to inform the clock trainer 410 that the training pattern is transmitted. The clock-embedded data transmitter 220 may transmit the clock-embedded data signal CED to the clock trainer 410 and the decoder 440 of the data-sensing driver 400.

The shared back channel receiver 230 may provide the information TT about the set frame number and a second lock fail signal LF2 to the shared forward channel transmitter 210 and the clock-embedded data transmitter 220. The shared back channel receiver 230 may provide the second lock fail signal LF2 to the shared forward channel transmitter 210 and the clock-embedded data transmitter 220 when the shared back channel signal SBC has a low value. Based on the second lock fail signal LF2 received from the shared back channel receiver 230, the clock-embedded data transmitter 220 may provide the clock-embedded data signal CED that includes the training pattern. The clock-embedded data transmitter 220 may determine whether to include the training pattern in the clock-embedded data signal CED based on information TT about the set frame number. The shared forward channel transmitter 210 may change the shared forward channel signal SFC to a low value when the shared forward channel transmitter 210 receives the second lock fail signal LF2. The shared forward channel transmitter 210 may determine the value of the shared forward channel signal SFC based on the information TT about the set frame number.

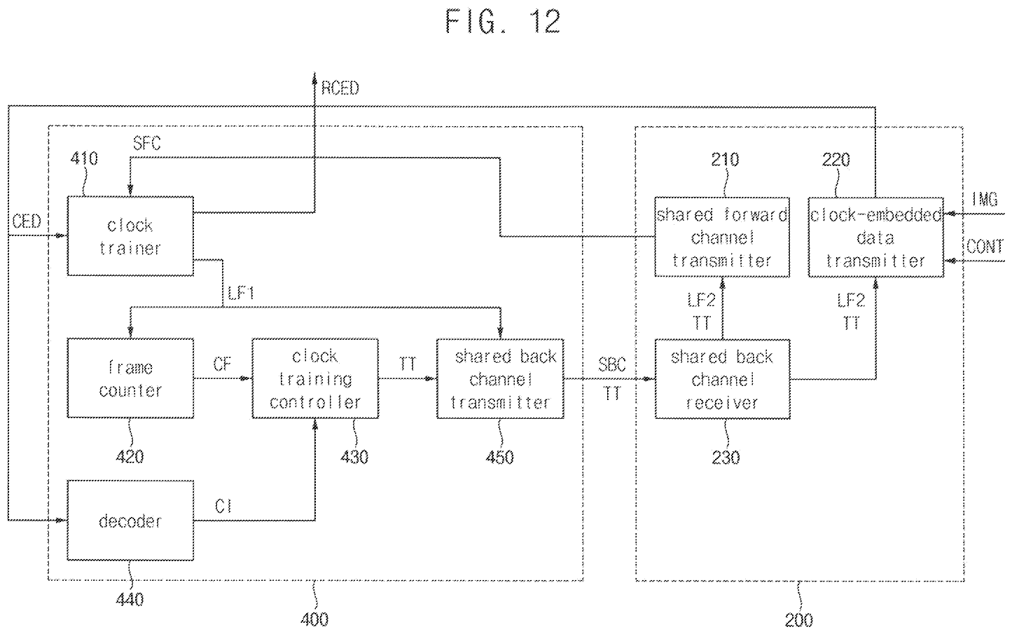

FIG. 13 is a graph illustrating a relationship between a time count number and a set frame number in a normal clock recovery operation according to an embodiment of the present inventive concept.

Referring to FIG. 13, the data-sensing driver 400 may determine the set frame number depending on a time count number, and perform the clock training operation using the training pattern in the blank period VBP of one frame of one or more frames that are set by the set frame number. The data-sensing driver 400 may count time and generate the time count number. The set frame number may be changed as the time count number is increased by a reference time. The set frame number may be increased by one as the time count number is increased by the reference time.

In the present example in which the reference time is 150 ms, the set frame number may increase by one frame as the time count number is increased by 150 ms. As a result, the data-sensing driver 400 may perform the clock training operation per one frame while the time count number is between 0 and 150 ms. The data-sensing driver 400 may perform the clock training operation per two frames while the time count number is between 150 ms and 300 ms.

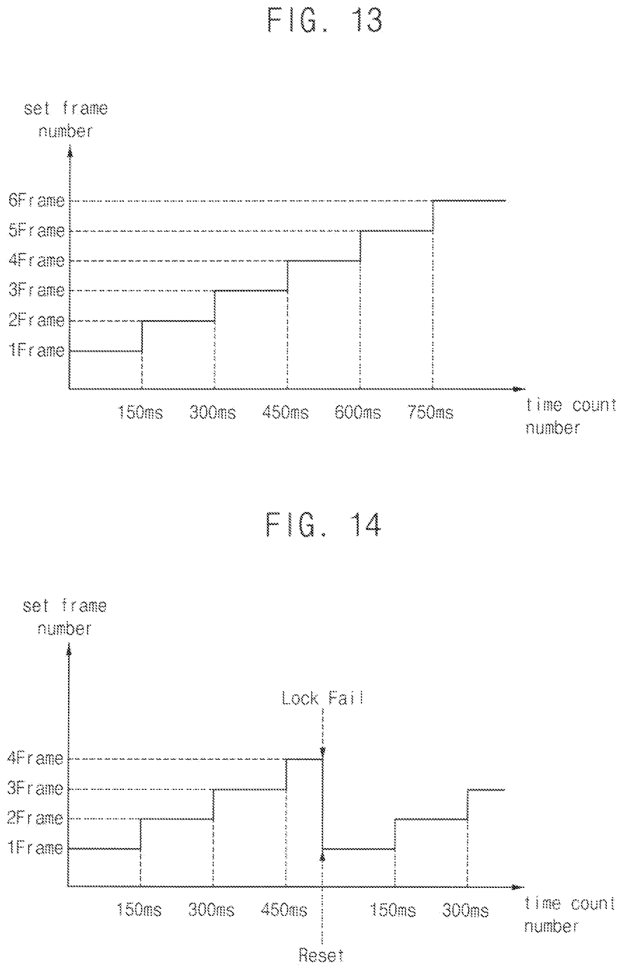

FIG. 14 is a graph illustrating a relationship between the time count number and the set frame number in an event of a lock fail according to an embodiment of the present inventive concept.

Referring to the FIG. 14, when a lock fail occurs or a clock recovery operation is abnormally performed, the data-sensing driver 400 may initialize or reset the time count number and perform the clock training operation in a next frame.

For example, when the lock fail occurs, the data-sensing driver 400 may initialize or reset the time count number, and repeat the clock recovery operation. As a result, the set frame number may be determined depending on the time count number initialized.

In the present example in which the reference time is 150 ms, the set frame number may be increased by one frame as the time count number is increased by 150 ms. As a result, the data-sensing driver 400 may perform the clock training operation per one frame while the time count number is between 0 and 150 ms. The data-sensing driver 400 may perform the clock training operation per two frames while the time count number is between 150 ms and 300 ms. Upon detecting the lock fail, the data-sensing driver 400 may reset the time count number and perform the clock training operation per one frame in the next 150 ms and repeat the clock training operation by increasing the set frame number every 150 ms.

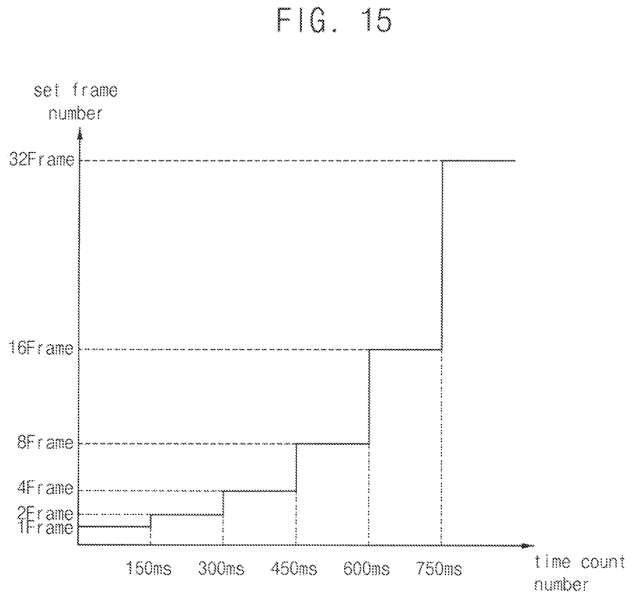

FIG. 15 is a graph illustrating a relationship between a time count number and a set frame number in a normal clock recovery operation according to an embodiment of the present disclosure.

Referring to FIG. 15, the set frame number is doubled as the time count number is increased by the reference frame number.

In the present example in which the reference time is 150 ms, the set frame number may be initially increased by one as the time count number reaches 150 ms. The set frame number may be increased to two frames that is a double of the initial set frame number as the time count number reaches 300 ms. Next, the set frame number may be increased to four that is a double of the previous set frame number as the time count number reaches 450 ms. Accordingly, the data-sensing driver 400 may initially perform the clock training operation per one frame while the time count number is between 0 and 150 ms. Subsequently, the data-sensing driver 400 may perform the clock training operation per two frames while the time count number is between 150 ms and 300 ms, may perform the clock training operation per four frames while the time count number is between 300 ms and 450 ms, and may repeat the clock training operation.

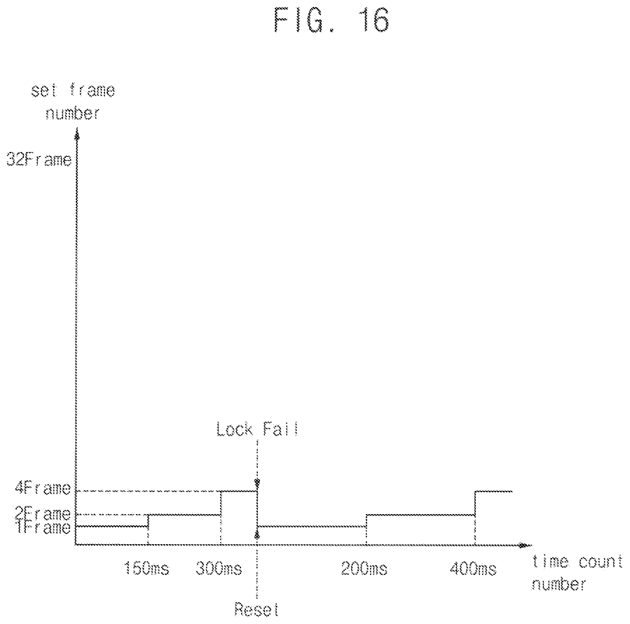

FIG. 16 is a graph illustrating a relationship between a time count number and a set frame number in an event of a lock fail according to an embodiment of the present inventive concept.

Referring to FIG. 16, when a lock fail occurs or a clock recovery operation is abnormally performed, the data-sensing driver 400 may initialize the time count number and perform the clock training operation in a next frame. After the set frame number is initialized or reset, the reference time may be increased when the clock recovery operation is abnormally performed, in the present example, from 150 ms to 200 ms.

In the present example in which the first reference time is 150 ms, the set frame number may be doubled as the time count number increases by 150 ms. As a result, the data-sensing driver 400 may perform the clock training operation per one frame while the time count number is between 0 and 150 ms. The data-sensing driver 400 may perform the clock training operation per two frames while the time count number is between 150 ms and 300 ms. Upon detecting the lock fail, the data-sensing driver 400 may initialize the time count number and perform the clock training operation per one frame again. After the lock fail, the reference time may be increased from 150 ms to 200 ms. As a result, the data-sensing driver 400 may perform the clock training operation per one frame while the tie count number is between the next 0 and 200 ms. The data-sensing driver 400 may perform the clock training operation per two frames while the time count number is between the next 200 ms and 400 ms.

The data-sensing driver 400 may check deterioration of the display panel 100 in real time by performing the sensing operation during the blank period VBP while the display apparatus displays an image. The present inventive concept may not necessarily perform the clock training operation every frame. For example, the data-sensing driver 400 may perform the sensing operation while not performing the clock training operation. Accordingly, the data-sensing driver 400 may perform sensing operations more frequently during the blank period VBP. As a result, the display apparatus may advance completion of the sensing operation. The present inventive concept may quickly sense deterioration of the display panel 100 and prevent or reduce a momentary afterimage.

The foregoing is illustrative of the present inventive concept and is not to be construed as limiting thereof. Although some embodiments of the present inventive concept have been described, those skilled in the art will readily appreciate that modifications and deviations are possible in the disclosed embodiments without materially departing from the novel teachings and advantages of the present inventive concept. Accordingly, such modifications and deviations are intended to be included within the scope of the present inventive concept including the claims. In the claims, means-plus-function clauses are intended to cover the structures described herein as performing the recited function and not only structural equivalents but also equivalent structures. Therefore, it is to be understood that the foregoing is illustrative of the present inventive concept and is not to be construed as limited to the specific embodiments disclosed, and that modifications and deviations to the disclosed embodiments, as well as other embodiments, are intended to be included within the scope of the present inventive concept. The present inventive concept may be defined by the following claims, with equivalents of the claims to be included therein.

What is claimed is:

1. A display apparatus comprising:
a display panel including a plurality of pixels;
a gate driver configured to provide gate signals to the plurality of pixels;
a driving controller configured to provide a clock-embedded data signal that includes image data and a training pattern; and
a data-sensing driver configured to receive the clock-embedded data signal from the driving controller, and provide data voltages corresponding to the image data to the plurality of pixels in an active period,
wherein the data-sensing driver determines a set frame number depending on a frame count number, and performs a clock training operation based on the training pattern in a blank period of one frame of one or more frames that are set by the set frame number.

2. The display apparatus of claim 1, wherein the data-sensing driver performs a sensing operation in the blank period while the clock training operation is not performed.

3. The display apparatus of claim 2, wherein the data-sensing driver generates the frame count number by counting a number of frames, and
wherein, in a case in which a clock recovery operation is abnormally performed, the data-sensing driver initializes the frame count number and performs the clock training operation in a subsequent frame.

4. The display apparatus of claim 3, wherein the driving controller provides set information about a plurality of set frame numbers corresponding to a plurality of frame count numbers to the data-sensing driver.

5. The display apparatus of claim 4, wherein the data-sensing driver informs the driving controller whether the clock recovery operation is normal or abnormal through a shared back channel.

6. The display apparatus of claim 5, wherein the driving controller informs the data-sensing driver that the training pattern is transmitted in the clock-embedded data through a shared forward channel.

7. The display apparatus of claim 6, wherein the set frame number is changed as the frame count number is increased by a reference frame number.

8. The display apparatus of claim 7, wherein the set frame number is increased by one as the frame count number is increased by the reference frame number.

9. The display apparatus of claim 7, wherein the set frame number is doubled as the frame count number is increased by the reference frame number.

10. The display apparatus of claim 7, wherein the reference frame number is increased when the clock recovery operation is abnormally performed.

11. A display apparatus comprising:
a display panel including a plurality of pixels;
a gate driver configured to provide gate signals to the plurality of pixels;
a data-sensing driver; and
a driving controller configured to provide a clock-embedded data signal that includes image data, a training pattern, and set information,
wherein the data-sensing driver comprises:
a clock trainer configured to receive the clock-embedded data signal from the data controller and output the image data in an active period, perform a clock training operation based on the training pattern in a blank period, and output a first lock fail signal in response to an abnormal clock recovery operation;
a frame counter configured to generate a frame count number by counting a number of frames; and
a clock training controller configured to receive the frame count number and the set information about a plurality of set frame numbers corresponding to a plurality of frame count numbers, and determine a set frame number among the plurality of set frame numbers depending on the frame count number, and
wherein the driving controller comprises:
a shared forward channel transmitter configured to provide a shared forward channel signal that informs the clock trainer that the training pattern is transmitted; and
a clock-embedded data transmitter configured to transmit the clock-embedded data signal to the data-sensing driver.

12. The display apparatus of claim 11, wherein the data-sensing driver further comprises:
a decoder configured to receive the clock-embedded data signal and decode the set information; and
a shared back channel transmitter configured to generate a shared back channel signal based on the first lock fail signal, and transmit information about the set frame number and the shared back channel signal to a shared back channel receiver, and
wherein the driving controller further comprises the shared back channel receiver that is configured to generate a second lock fail signal based on the shared back channel signal, and provide the information about the set frame number and the second lock fail signal to the shared forward channel transmitter and the clock-embedded data transmitter.

13. A display apparatus comprising:
a display panel including a plurality of pixels;
a gate driver configured to provide gate signals to the plurality of pixels;
a driving controller configured to provide a clock-embedded data signal that includes image data and a training pattern; and
a data-sensing driver configured to receive the clock-embedded data signal from the driving controller, and provide data voltages corresponding to the image data to the plurality of pixels in an active period,
wherein the data-sensing driver determines a set frame number depending on a time count number, and performs a clock training operation based on the training pattern in a blank period of one frame of one or more frames that are set by the set frame number.

14. The display apparatus of claim 13, wherein the data-sensing driver performs a sensing operation in the blank period while the clock training operation is not performed.

15. The display apparatus of claim 14, wherein the data-sensing driver generates the time count number by counting time, and
wherein, in a case in which a clock recovery operation is abnormally performed, the data-sensing driver initializes the time count number and performs the clock training operation in a subsequent frame.

16. The display apparatus of claim 15, wherein the driving controller provides set information about a plurality of set frame numbers corresponding to a plurality of time count numbers to the data-sensing driver.

17. The display apparatus of claim 16, wherein the data-sensing driver informs the driving controller whether the clock recovery operation is normal or abnormal through a shared back channel, and
wherein the driving controller informs the data-sensing driver that the training pattern is transmitted in the clock-embedded data through a shared forward channel.

18. The display apparatus of claim 17, wherein the set frame number is changed as the time count number is increased by a reference time.

19. The display apparatus of claim 18, wherein the set frame number is increased by one as the time count number is increased by the reference time.

20. The display apparatus of claim 18, wherein the reference time is increased when the clock recovery operation is abnormally performed.
